(19) United States
(12) Patent Application Publication
(10) Pub. No.: US 2005/0069165 A1
(43) Pub. Date: Mar. 31, 2005

(54) Speaker assembly having vibrating element and magnetic loops

(76) Inventor: Lain-Chiao Wu, Tu-Cheng City (TW)

Correspondence Address: Lain-Chiao Wu, P.O. Box No. 6-57, Junghe, Taipei, 235, TW

(21) Appl. No.: 10/672,736

(22) Filed: Sep. 29, 2003

(51) Int. Cl. H04R 1/00; H04R 9/06; H04R 11/02

(52) U.S. Cl. 381/401; 381/400; 381/402

(57) ABSTRACT

A speaker assembly having a vibrating element and magnetic loops includes a frame, wherein the frame is provided with a vibrating element. The vibrating element has at least two sound coils, with each sound coil joined with a connecting wire; and at least two driving assemblies having two corresponding round or oval magnetic loops at one side thereof, with the magnetic loops accommodated at end portions of the sound loops, thereby forming a speaker assembly. The speaker assembly has volume increased by at least 50% and relatively reduced power consumption, thereby economizing electricity.

### BACKGROUND OF THE INVENTION

(a) Field of the Invention

The invention relates to a speaker assembly having a vibrating element and magnetic loops, and more particularly, to a speaker assembly having increased volume accomplished in a more power-saving means without enlarging dimensions thereof. According to the speaker assembly, a vibrating element is provided with at least two sound coils, wherein each sound coil is joined with a connecting wire. At least two driving assemblies are disposed, with a round magnetic loop formed at one side of each driving assembly. The magnetic loops are accommodated around end portions of the sound coils, thereby forming a speaker assembly offering convenience and practical values.

(b) Description of the Prior Art

Speakers applied in laptop computers and liquid crystal displays (LCD) usually do not support high volumes. The reasons behind are that the speakers are embedded at an interior with insufficient power sent out. Wherein, a small speaker is disposed with a vibrating element having a driving assembly at a center portion thereof. The driving assembly is consisted of a washer, a magnetic and a yoke. However, spaces for speakers applied in laptop computers and LCD are restricted, and volume of the speakers are resultantly insufficient due to smaller dimensions thereof. This is a major drawback of the prior speakers.

In addition, suppose the above drawback is solved merely by increasing quantity of speakers, it is inevitable that power consumption becomes too large to handle while also not having enough spaces either. The drawback remains unsolved.

### SUMMARY OF THE INVENTION

The primary object of the invention is to provide a speaker assembly comprising a vibrating element in an appropriate shape and provided with a driving assembly, wherein the driving assembly has at least two sets of sound coils, magnets and driving loops. In a largest magnetic field possible and having certain dimensions, the vibrating element is allowed with volume increased by at least 50% and relatively reduced power consumption, thereby economizing electricity.

The other object of the invention is to manufacture the sound coils and the driving assembly into an integral. For example, the sound coils are processed into oval in shape, and the driving assembly is correspondingly processed into oval in shape as well, thereby providing a more solid structure formed with a facilitated assembly process.

### BRIEF DESCRIPTION OF THE DRAWINGS

FIG. 1 shows an exploded structural view according to the invention.

FIG. 2 shows an elevational view according to the invention.

FIG. 3 shows an exploded partial structural view from another angle according to the invention.

FIG. 4 shows side structural view according to the invention.

FIG. 5 shows a structural view of an embodiment according to the invention.

### DETAILED DESCRIPTION OF THE PREFERRED EMBODIMENTS

To better understand the contents of the invention, detailed descriptions shall be given with the accompanying drawings below.

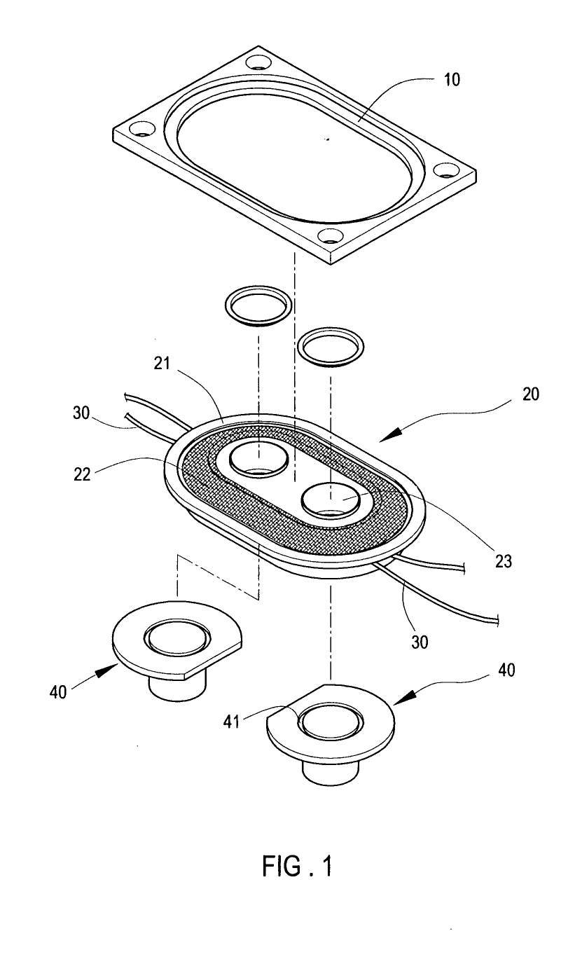

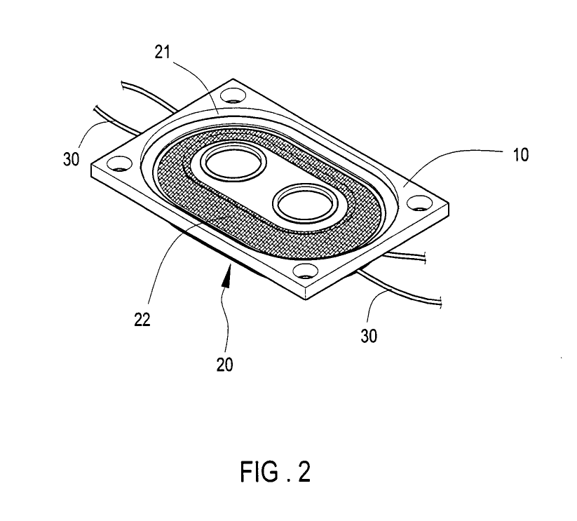

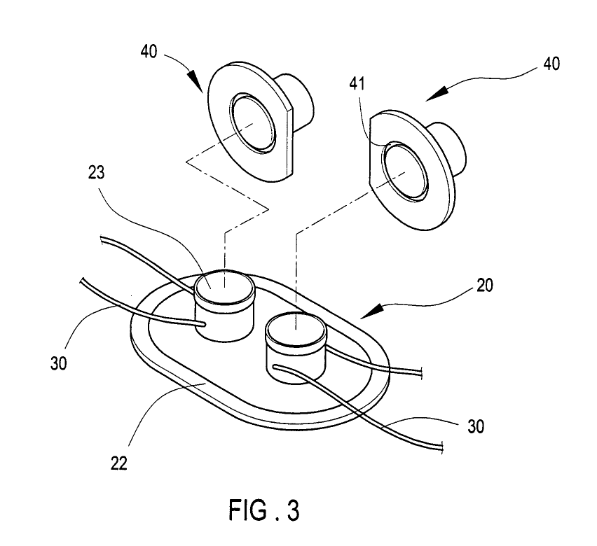

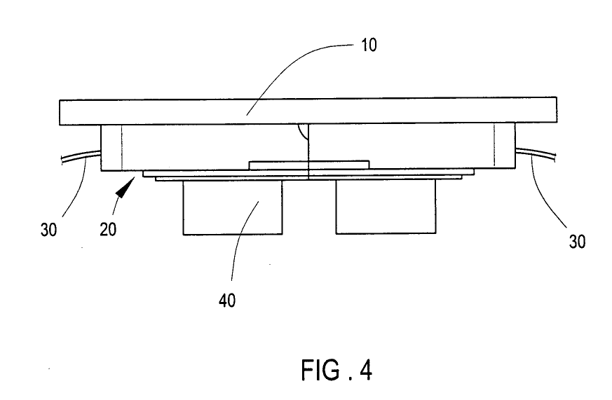

Referring to FIGS. 1, 2, 3 and 4, a speaker assembly according to the invention comprises a frame 10; a vibrating element 20 disposed at a center portion of the frame 10, wherein the vibrating element 20 has hard rim 21 at a periphery thereof, a vibrator 22 filled at a center portion thereof, and at least two sound coils 23 at a center portion of the vibrator 22; a connecting wire joined with each of the sound coils 23; and at least two driving assemblies 40, wherein each driving assembly 40 has a magnetic loop 41 made of a washer, a magnet, or a yoke, with the magnetic loops 41 exactly accommodated at end portions of the sound coils 23 to form a speaker assembly.

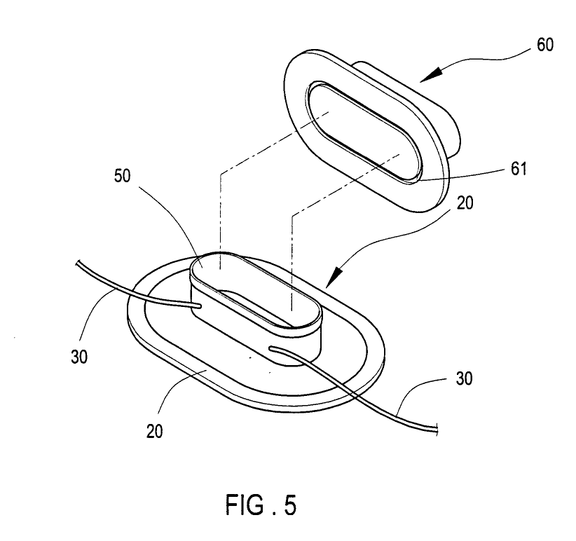

Referring to FIG. 5 showing another embodiment according to the invention, a driving assembly 60 is directly manufactured into a part having appropriate dimensions, and is provided with a round magnetic loop 61. In addition, a sound coil 50 for corresponding with the vibrating element 20 is formed in an oval shape, thereby offering better strength and facilitated assembly.

According to the invention, a speaker assembly is provided with at least two sets of coils and magnetic loops, and therefore volume and timbre of the speaker assembly are enhanced. The coils and the magnetic loops may also be designed as oval in shape, so that not only volume is increased by 50%, but also effects as providing reduced dimensions and power consumption are also achieved.

It is of course to be understood that the embodiments described herein are merely illustrative of the principles of the invention and that a wide variety of modifications thereto may be effected by persons skilled in the art without departing from the spirit and scope of the invention as set forth in the following claims.

1. A speaker assembly having a vibrating element and magnetic loops comprising a frame, wherein the frame is provided with a vibrating element at a center portion thereof; and characteristics thereof being: the vibrating element has at least two sound coils, with each sound coil joined with a connecting wire; and at least two driving assemblies having two corresponding round magnetic loops at one side thereof, with the magnetic loops accommodated at end portions of the sound loops, thereby forming a speaker assembly.

2. The speaker assembly having a vibrating element and magnetic loops in accordance with claim 1, wherein the two sets of corresponding sound coils and magnetic loops are joined and formed as oval in shape.
